(19) United States
(12) Patent Application Publication
(10) Pub. No.: US 2005/0220378 A1
(43) Pub. Date: Oct. 6, 2005

(54) Bearing unit and rotation and drive device

(75) Inventors: Takeshi Kaneko, Chiba (JP); Kenichiro Yazawa, Tokyo (JP); Yuji Shishido, Kanagawa (JP); Kiyoyuki Takada, Chiba (JP); Yoshiaki Kakinuma, Tokyo (JP); Hiroshi Sato, Chiba (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Shinagawa-ku, Tokyo (JP)

(21) Appl. No.: 10/512,826

(22) PCT Filed: Mar. 1, 2004
(86) PCT No.: PCT/JP04/02477

§ 371 Date: Apr. 25, 2005

(30) Foreign Application Priority Data
Mar. 4, 2003 (JP) 2003-056696

(51) Int. Cl. F16C 32/06

(52) U.S. Cl. 384/100

(57) ABSTRACT

The present invention relates to bearing unit for supporting a shaft 2 so as to freely rotate and includes a radial bearing 4 for supporting the shaft 2 so as to freely rotate and a housing member 6 made of a resin for holding the radial bearing 4. The housing member 6 is formed with a material having a coefficient of thermal contraction larger than that of a material used for the radial bearing 4. Assuming that the radial thickness of the radial bearing 4 is m and the radial thickness of a housing main body part of the housing member 6 with which the outer periphery of the radial bearing is covered is n, a relation of m>n is satisfied. Thus, an influence due to a thermal contraction upon molding is prevented from being applied to the radial bearing.

### TECHNICAL FIELD

The present invention relates to a bearing unit and a rotary driving apparatus using this bearing unit, and more particularly to a bearing unit and a rotary driving apparatus using the bearing unit in which a mechanical accuracy is maintained and a reliability is improved.

This application claims a priority based on Japanese Patent Application No. 2003-056696 filed in Mar. 4, 2003 in Japan, which is applied to this application by referring thereto.

### BACKGROUND ART

As a conventional bearing unit that accurately supports a rotary shaft and is excellent in its durability, there is, for instance, a bearing unit of a cooling fan used for cooling a heat generating device such as a CPU (a central processing unit) or a bearing unit of a rotary drum driving motor used for a recording and reproducing apparatus using a tape recording medium. As such a bearing unit, a bearing unit using a fluid dynamic bearing as disclosed in Japanese Patent Application Laid-Open No. 2000-205243 has been known. Further, the applicant of this application proposes bearing units in the specifications and the drawings of Japanese patent Application Laid-Open No. 2003-130043 or Japanese Patent Application Laid-Open No. 2003-232341.

A conventionally employed bearing unit has such problems as described below from the viewpoint of reliability or mechanical accuracy.

For instance, in the bearing unit using a metallic housing member, component members are hardly completely combined or fastened to each other and the leakage of lubricating oil is hardly assuredly prevented. Further, it is a complicated and expensive work to apply a polymer packing material such as an adhesive to the entire periphery of a fastening part without unevenness. Further, an inspection method for recognizing whether or not the fastening part is completely sealed without a space is hardly obtained. As a result, a sufficient reliability cannot be obtained or an expensive facility is required.

Further, in the bearing unit using a housing member made of a resin, for instance, when the housing member is formed by a material having a coefficient of thermal contraction higher than that of a material used for a radial bearing, a stress to the direction of an inside diameter generated upon thermal contraction of the housing member is undesirably adversely effected on the radial bearing. That is, a clearance required between a shaft and the radial bearing can not be sufficiently ensured so that a mechanical accuracy may be possibly hardly maintained.

### DISCLOSURE OF THE INVENTION

It is an object of the present invention to provide a new bearing unit and a rotary driving apparatus using the bearing unit that can solve the above-described problems of a prior art.

It is another object of the present invention to provide a bearing unit capable of assuring a mechanical accuracy between a shaft and a radial bearing for supporting the shaft and excellent in its durability and a rotary driving apparatus using the bearing unit.

In a bearing unit according to the present invention proposed for achieving the above-described objects, when a housing member made of a resin for holding the radial bearing is formed with a material having a coefficient of thermal contraction larger than that of a material used for the radial bearing, assuming that the radial thickness of the radial bearing is m and the radial thickness of a part of the housing member with which the outer periphery of the radial bearing is covered is n, a relation of m>n is satisfied.

Further, the present invention concerns a rotary driving apparatus using the above-described bearing unit.

In the bearing unit according to the present invention, the radial bearing is held from its outer periphery by using the housing member made of the resin. Further, the relation between the radial thickness m of the radial bearing and the radial thickness n of the part of the housing member with which the outer periphery of the radial bearing is covered satisfies m>n. Thus, a stress (compressive force) to the direction of an inside diameter during the thermal contraction of the housing member can be reduced to prevent the radial bearing from being compressed.

Still another objects of the present invention and specific advantages obtained by the present invention will be more apparent from the following description of embodiments made by referring to the drawings.

### BRIEF DESCRIPTION OF THE DRAWINGS

FIG. 1 is a sectional view showing a bearing unit according to the present invention.

FIG. 2 is a sectional view showing that the relation between the thickness m of a radial bearing and the thickness n of a housing member satisfies m<n.

FIG. 3 is a sectional view showing another embodiment of a bearing unit according to the present invention.

FIG. 4 is a sectional view showing a still another embodiment of a bearing unit according to the present invention.

FIG. 5 is a sectional view showing a still another embodiment of a bearing unit according to the present invention.

FIG. 6 is a sectional view showing a rotary driving apparatus using the bearing unit according to the present invention.

### BEST MODE FOR CARRYING OUT THE INVENTION

Now, a bearing unit according to the present invention and a rotary driving apparatus using the bearing unit will be described below by referring to the drawings.

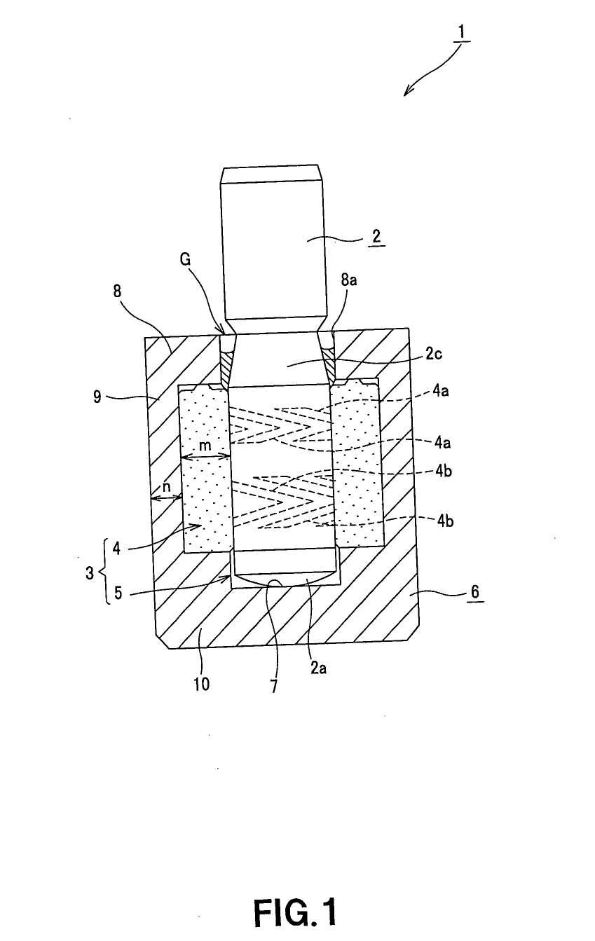

Firstly, a first embodiment of the bearing unit according to the present invention will be described by referring to the drawings. As shown in FIG. 1, the bearing unit 1 has a shaft 2 formed by using a metallic material such as stainless steel or a resin material and a bearing mechanism 3 for supporting the shaft 2. Here, as the shaft 2, a rotary shaft supported by the bearing mechanism 3 so as to freely rotate is used. Further, the bearing mechanism 3 includes a radial bearing 4 for receiving a radial load exerted on the shaft 2 and a thrust bearing 5 for receiving a thrust load. The bearing mechanism 3 is housed in a housing member 6 serving as a support member of the shaft 2, or formed as a part of the housing member 6.

Then, as the radial bearing 4 for supporting the shaft 2 so as to freely rotate with respect to a radial direction, for instance, an oil impregnated sintered bearing or a fluid dynamic bearing is used. The fluid dynamic bearing used here is specifically explained. The fluid dynamic bearing is formed by molding copper based or copper-iron based sintered metal in a cylindrical form and has two sets of grooves 4a and 4b for generating dynamic pressure formed on its inner peripheral surface. These dynamic pressure generating grooves 4a and 4b are formed by successively extending V shaped grooves in the direction of a circumference. Further, the fluid dynamic bearing is impregnated with lubricating oil by employing the porous structure of the sintered metal forming the bearing.

In this embodiment, the dynamic pressure generating grooves 4a and 4b forming the fluid dynamic bearing are formed on the inner peripheral surface of the radial bearing 4, however, the grooves may be formed on the outer peripheral surface of the shaft 2 supported by the radial bearing 4.

In this embodiment, the two sets of the dynamic pressure generating grooves 4a and 4b are provided in parallel in the axial direction on the inner peripheral surface of the radial bearing 4.

Further, as the thrust bearing 5 for supporting the shaft 2 in the thrust direction, a pivot bearing or a fluid dynamic bearing is used. In the embodiment shown in FIG. 1, for the thrust bearing 5, the pivot bearing is used that the end part 2a of the shaft 2 formed in a protruding curved surface such as a spherical surface is supported by a support surface 7 of the housing member 6. In this embodiment, the housing member 6 forms a part of the thrust bearing 5. That is, a support member for supporting the end part 2a of the shaft 2 may be formed separately from the housing member 6. However, the support member is formed integrally with the housing member 6 so that the number of parts can be reduced and a manufacturing cost can be reduced.

The housing member 6 having the radial bearing 4 housed therein and the thrust bearing 5 also functions to hold lubricating oil with which a gap formed between the shaft 2 and the radial bearing 4 and the trust bearing 5 for supporting the shaft 2 is filled. Accordingly, the housing member 6 is formed with a material capable of preventing the leakage of the lubricating oil. Specifically, the housing member 6 is formed by molding a polymer material such as nylon (straight chain aliphatic polyamide), liquid crystal polymer (LCP), polyimide, or the like.

The housing member 6 is formed in the cylindrical shape with a bottom by using a polymer material having a coefficient of thermal contraction larger than that of the sintered metal forming the radial bearing 4. Namely, the housing member 6 includes a lubricating oil seal part 8, a housing main body part 9 in the outer peripheral side of the radial bearing 4, and a bottom part 10 by which the thrust bearing 5 is formed. A gap G is formed between the inner peripheral surface 8a of the lubricating oil seal part 8 and the shaft 2.

In this invention, when the radial thickness of the radial bearing 4 is set to m and the radial thickness of the housing main body part 9 forming the housing member 6 is set to n, a relation of m>n is established between them. That is, the thickness n of the housing main body part 9 with which the outer periphery of the radial bearing 4 is covered is smaller than the thickness m of the radial bearing 4 in the radial direction from the shaft 2 as a center.

In the bearing unit 1 according to the present invention, an outsert molding is carried out by arranging the radial bearing 4 in a metal mold for forming the housing member 6 made of the polymer material. Thus, the radial bearing 4 can be easily and highly accurately arranged in the housing member 6. Further, a part of the housing member 6 is used to form the thrust bearing 5 and the lubricating oil seal part 8 is formed integrally with the housing member 6. Thus, the number of parts or the number of manufacturing steps can be reduced and the manufacturing cost can be reduced.

Further, the housing member 6 for housing and supporting the bearing mechanism 3 has an integral seamless structure. Thus, the leakage of the lubricating oil can be prevented and the bearing unit excellent in its reliability can be formed.

Here, the above-described relation of m>n will be described below. Since the housing member 6 is ordinarily formed with the polymer material higher in the coefficient of thermal contraction than metal, a stress exerted on the radial bearing 4 upon thermal contraction in a molding process causes a problem.

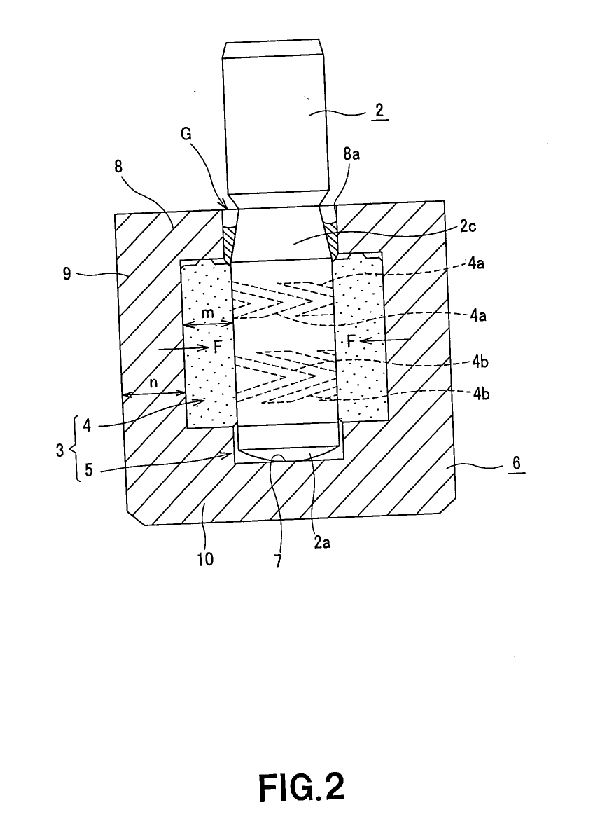

For instance, when the housing member 6 is formed by outsert molding in the outer periphery of the radial bearing 4 formed by using the sintered metal made of copper or iron, assuming that a relation of m<n is established as shown in FIG. 2, high molding temperature is cooled to ordinary temperature. At this time, the housing main body part 9 of the housing member 6 compresses the radial bearing 4 located in the inner peripheral side thereof in the radial direction, that is, toward a direction shown by an arrow mark F coming near to the shaft 2 in FIG. 2. Thus, the inside diameter of the radial bearing 4 is undesirably contracted.

Since a radial clearance between the shaft 2 and the radial bearing 4 for supporting the shaft 2 ordinarily needs to be held to about 1 μm to 10 μm, and desirably to about several μm, the large contraction of the inside diameter of the radial bearing 4 causes an unallowable problem to the bearing unit.

Thus, in the present invention, the relation between the radial thickness m of the radial bearing 4 and the radial thickness n of the housing main body part 9 of the housing member 6 satisfies m>n. Consequently, a quantity of thermal contraction of the housing member 6 is reduced and the rigidity of the radial bearing 4 is improved in a relative relation to the housing member 6. Accordingly, even when the housing member 6 is outsert-molded in the periphery of the radial bearing 4 by using the polymer material or the like, the inside diameter of the radial bearing 4 is not contracted by the thermal contraction of the housing member 6. Therefore, a highly precise mechanical accuracy can be maintained, and a good lubrication to the shaft 2 and the stable rotation of the shaft 2 can be realized.

The fact that the radial thickness m of the radial bearing 4 and the radial thickness n of the housing main body part 9 of the housing member 6 establish the relation of m>n can be obtained under a condition that a quantity of radial contraction of the radial bearing 4 is not lower than a quantity of radial contraction of the housing member 6 in the radial direction of the shaft 2 as a center on the assumption that a material forming the housing member 6 has a coefficient of linear expansion larger than that of a material forming the radial bearing 4. The above-described relation is not directly related to kinds of materials forming the radial bearing 4 or the housing member 6.

In this embodiment, to prevent the leakage of the lubricating oil in a part in which the shaft 2 protrudes to an outer part from the end of the housing member 6, a part that forms the gap G between the inner peripheral surface 8a of the seal part 8 and the shaft 2 is formed as a tapered part 2c in which the diameter is reduced along the shaft 2 toward the end and the diameter is enlarged as the shaft comes near to the radial bearing 4 in the inner direction of the housing member 6. That is, the gap G is formed between the tapered part 2c formed so that the diameter becomes gradually large toward the inner part and the inner peripheral surface 8a of the seal part 8 opposed thereto. Accordingly, a quantity of gap is gradually decreased toward the inner part of the housing member 6. Then, pull-in pressure generated due to a capillary action is inversely proportional to the quantity of gap. Thus, as the quantity of gap is more decreased, the generated pull-in pressure is the more increased. Thus, the lubricating oil existing in the gap is pulled in the inner part of the housing member 6 having a small quantity of gap. Accordingly, the lubricating oil can be prevented from moving outside and leaking. Further, the bias of the lubricating oil due to eccentricity is more effectively reduced than a case that the diameter of a hole is constant. Further, the lubricating oil can be effectively prevented from being scattered outside by the action of a centrifugal force upon rotation of the shaft 2.

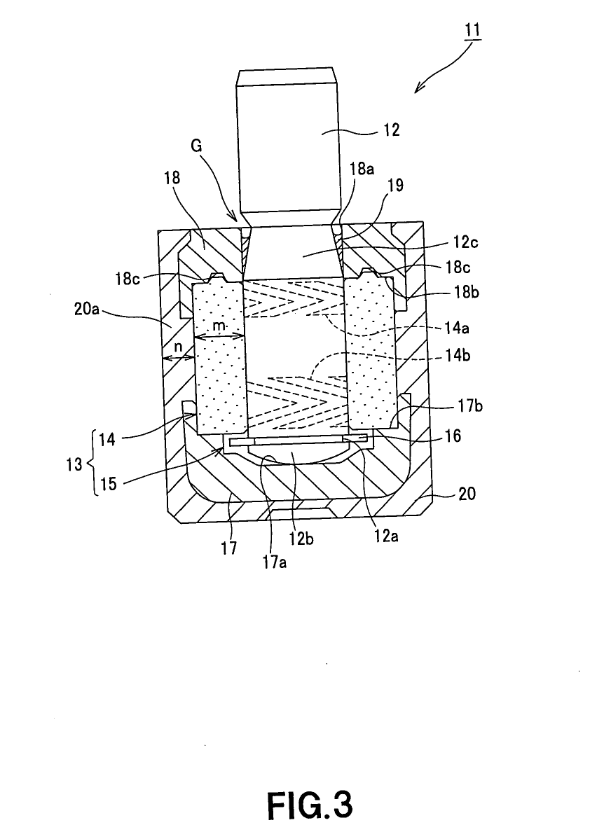

Now, another embodiment of a bearing unit according to the present invention will be described below by referring to FIGS. 3 to 5.

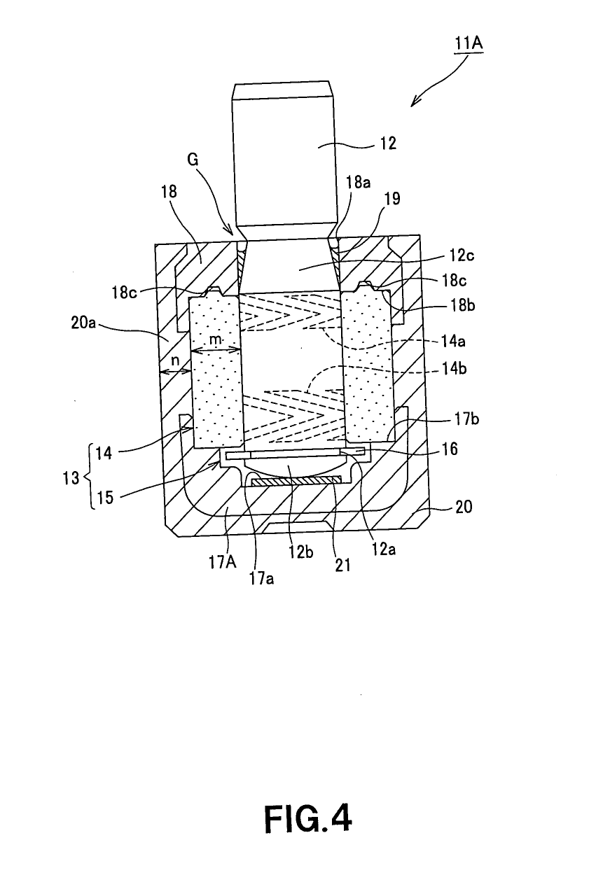

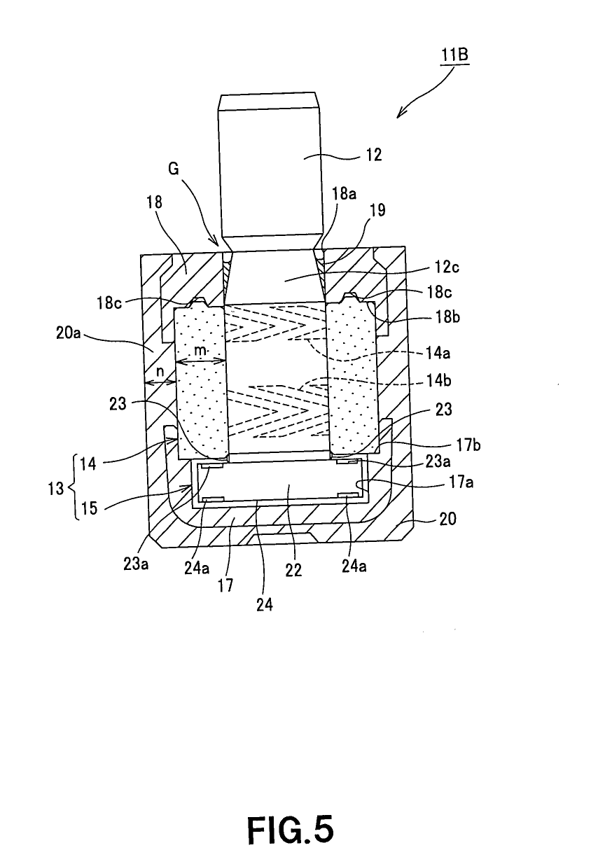

A bearing unit 11 shown FIGS. 3 and 4 uses a pivot bearing as a thrust bearing. A bearing unit 11 shown in FIG. 5 uses a fluid dynamic bearing as a thrust bearing.

In the bearing unit 11 shown in FIG. 3, an end of a shaft 12 is worked to a spherical part and the spherical part is supported by the thrust bearing formed with a polymer material.

The bearing unit 11 shown in FIG. 3 includes a shaft 12 formed by using a metallic material such as stainless steel and a bearing mechanism 13 for supporting the shaft 12. Here, as the shaft 12, a rotary shaft supported by the bearing mechanism 13 so as to freely rotate is used. Further, the bearing mechanism 13 includes a radial bearing 14 for receiving a radial load exerted on the shaft 12 and a thrust bearing 15 for receiving a thrust load. The bearing mechanism 13 is housed in a housing member 20 serving as a support member of the shaft 12.

Then, as the radial bearing 14 for supporting the shaft 12 so as to freely rotate with respect to a radial direction, for instance, a sintered oilless bearing or a fluid dynamic bearing is used. The fluid dynamic bearing used here is specifically explained. The fluid dynamic bearing is formed by molding copper based or copper-iron based sintered metal in a cylindrical form and has two sets of grooves 14a and 14b for generating dynamic pressure formed on its inner peripheral surface. These dynamic pressure generating grooves 14a and 14b are formed by successively extending V shaped grooves in the direction of a circumference. Further, the fluid dynamic bearing is impregnated with lubricating oil by employing the porous structure of the sintered metal forming the bearing.

In this embodiment, the two sets of the dynamic pressure generating grooves 14a and 14b forming the fluid dynamic bearing are formed on the inner peripheral surface of the radial bearing 14, however, the grooves may be formed on the outer peripheral surface of the shaft 12 supported by the radial bearing 14.

In this embodiment, the two sets of the dynamic pressure generating grooves 14a and 14b are provided in parallel in the axial direction on the inner peripheral surface of the radial bearing 14.

In the end side of the shaft 12 supported by the bearing mechanism 13, an annular engaging groove 12a is formed. A slip-off preventing member 16 is attached to the engaging groove 12a. The slip-off preventing member 16 is made of, for instance, a polymer material such as nylon or a metallic material. The slip-off preventing member 16 functions as a stopper for preventing the shaft 12 from moving toward a central axial direction and slipping off when external force is axially exerted due to a vibration or the change of atmospheric pressure is generated.

In the periphery of the slip-off preventing member 16, a member formed by using polymer materials such as nylon, polyimide, liquid crystal polymer or metal or the like, that is, a space forming member 17 is provided. The space forming member 17 is arranged to form a prescribed space in the periphery of the slip-off preventing member 16 by considering that the slip-off preventing member 16 is fixed to the shaft 12 and rotates together with the shaft 12.

In this embodiment, the space forming member 17 made of a synthetic resin is formed in a bottomed tubular form having a recessed part 17a. The spherically formed end of the shaft 12 comes into point-contact with a bottom surface of the recessed part 17a formed as a flat surface. As described above, a protruding curved surface is formed on the end 12b of the shaft 12 and comes into contact with the space forming member 17. Thus, a part of the space forming member 17 can form the thrust bearing 15. Accordingly, the thrust bearing does not need to be independently provided. Thus, a structure as the bearing unit 11 can be simplified, the number of parts can be reduced and a manufacturing cost can be reduced.

In the bearing unit 11 according to the present invention, a protruding part may be formed in the space forming member 17 side to support the end of the shaft 12 formed as a flat surface.

In an original space forming member 17, a step part 17b is formed. This step part 17b forms a receiving recessed part to which the radial bearing 14 is partly fitted.

A seal member 18 for sealing lubricating oil is disposed with a very small gap G formed between an inner peripheral surface 18a and the tapered part 12c of the shaft 12. The seal member is formed in a cylindrical shape by using a polymer material such as nylon or polytetrafluoroethylene or metal. In this seal member 18, a step part 18b is formed. This step part 18b forms a receiving recessed part to which the radial bearing 14 is partly fitted. A recess 18c formed in the seal member 18 is formed so as to correspond to a protruding part formed in the end part of the radial bearing 14. This protruding part serves as an index to discriminate a direction in the axial direction. The gap G is filled with lubricating oil 19.

The housing member 20 is formed by outsert-molding a synthetic resin such as a polymer material. In this embodiment, the housing member 20 serves to completely fasten the radial bearing 14, the space forming member 17 and the seal member 18 in a seamless manner without gaps. Thus, the leakage of the filled lubricating oil is prevented.

In this embodiment, between the radial thickness n of a housing main body part 20a of the housing member 20 with which the outer periphery of the radial bearing 14 is covered and the radial thickness m of the radial bearing 14, a relation of m>n is established in the same manner as that of the above-described bearing unit 1.

Now, a method for manufacturing the bearing unit 11 shown in FIGS. 3 and 4 will be briefly described.

To manufacture the bearing unit 11, the shaft 12 to which the slip-off preventing member 16 is attached is firstly inserted into the radial bearing 14 in a shaft inserting process.

Then, in an attaching process of the space forming member 17 and the seal member 18, the step part 17b of the space forming member 17 or the step part 18b of the seal member 18 is fitted to the outer peripheral edge of each of end parts in the axial direction of the radial bearing 14. Thus, the radial bearing 14 is partly fitted to each of the recessed parts of the space forming member 17 and the seal member 18. When this process is finished, the shaft 12 is already supported by the bearing mechanism 13 so as to freely rotate.

Then, in a forming process of the housing member 20, the housing member 20 is formed by outsert molding operation using the polymer material so that the relation between the radial thickness m of the radial bearing 14 and the radial thickness n of the housing main body part 20a forming the housing member 20 satisfies a condition of m>n. After that, the unit is filled with the lubricating oil by vacuum pressure impregnation in a lubricating oil filling and oil quantity adjusting process to adjust an oil quantity. The oil quantity is adjusted by removing excessive oil discharged outside by a thermal expansion, for instance, under the condition of prescribed temperature.

In the bearing unit 11 formed in such a way, a packing applied to the fastening part of the members as in the conventional bearing unit does not need to be managed so that a schedule control is simplified.

The above-described space forming member 17 is not limited to the member made of the synthetic resin and may be made of metal.

The bearing unit using the pivot bearing as the thrust bearing may be formed as shown in FIG. 4.

In a following description, parts common to those of the bearing unit 11 shown in FIG. 3 are designated by the same reference numerals and a detailed description thereof is omitted.

In a bearing unit 11A shown in FIG. 4, a space forming member 17A is formed by using metallic materials such as stainless steel, brass, pressed materials, sintered materials, etc.

Further, a thrust bearing 15 has a thrust bearing member 21 for receiving the end 12b of a shaft 12 worked to a spherical surface shape. The thrust bearing member 21 is attached to the recessed part 17a of the space forming member 17A. The thrust bearing member 21 is formed separately from the space forming member 17A by using a resin material such as nylon, polyimide, polyamide, liquid crystal polymer, etc. or a low friction material such as rubidium.

In the bearing unit 11A shown in FIG. 4, since the space forming member 17A is made of metal, the thrust bearing member 21 using the synthetic resin material or the low friction material is provided to realize a long life. Then, the rigidity of the space forming member 17A is improved and the space forming member has a structure capable of withstanding high temperature. Thus, conditions such as the filling temperature of a resin or pressure, etc. in an outsert molding process of a housing member 20 that is performed after the space forming member 17A is attached are mitigated. Namely, in this embodiment, there is a fear that a cost is increased because of the thrust bearing member 21. However, the resin material to be used is not selected and molding conditions are mitigated, so that a whole manufacturing cost can be reduced.

FIG. 5 shows still another embodiment of a bearing unit according to the present invention. The difference between a bearing unit 11B of this embodiment and the bearing unit 11 shown in FIG. 3 resides in the difference in the structure of the shaft 12 to be supported.

The shaft 12 used in the bearing unit 11B shown in FIG. 5 has an end of the shaft which is T-shaped in side view. A slip-off preventing member of the shaft 12 is used to form a fluid dynamic bearing. Accordingly, parts common to those of the bearing unit 11 shown in FIG. 3 are designated by the same reference numerals and a detailed description thereof is omitted.

In the bearing unit 11B shown in FIG. 5, the slip-off preventing member 22 provided in the end of the shaft 12 is formed in a disc having a prescribed thickness and made of metal such as brass or stainless steel, or polymer materials such as nylon, LCP, etc. On both end faces in the axial direction of the slip-off preventing member 22, that is, on a face 23 opposed to a radial bearing 14 and a face 24 opposed to a space forming member 17, dynamic pressure generating grooves 23a and 24a are respectively formed.

In the space forming member 17, a recessed part 17a for receiving the slip-off preventing member 22 is formed. Thus, a space is formed in the periphery of the slip-off preventing member 22. A gap formed between the slip-off preventing member 22 and the space forming member 17 or a gap formed between the slip-off preventing member 22 and the radial bearing 14 is filled with lubricating oil.

As described above, the bearing unit 11B shown in FIG. 5 has a structure of a fluid dynamic bearing type using the slip-off preventing member 22 and the space forming member 17 as a thrust bearing 15. Since the shaft 12 is supported to relatively freely rotate by the fluid dynamic bearing, a vibration is reduced. Accordingly, the bearing unit is preferably suitably used for a driving motor for a recording/reproducing device such as an optical disc drive or a hard disc drive.

Also in this embodiment, the radial thickness n of a housing main body part 20a of a housing member 20 with which the outer periphery of the radial bearing 14 is covered and the radial thickness m of the radial bearing 14 satisfy the relation of m>n.

Further, in this embodiment, the dynamic pressure generating grooves 23a and 24a are formed on the slip-off preventing member 22. However, the present invention is not limited thereto, and the dynamic pressure generating grooves may be formed on an end face of the radial bearing 14 opposed to the slip-off preventing member 22 or a face of the space forming member 17 opposed to the slip-off preventing member 22.

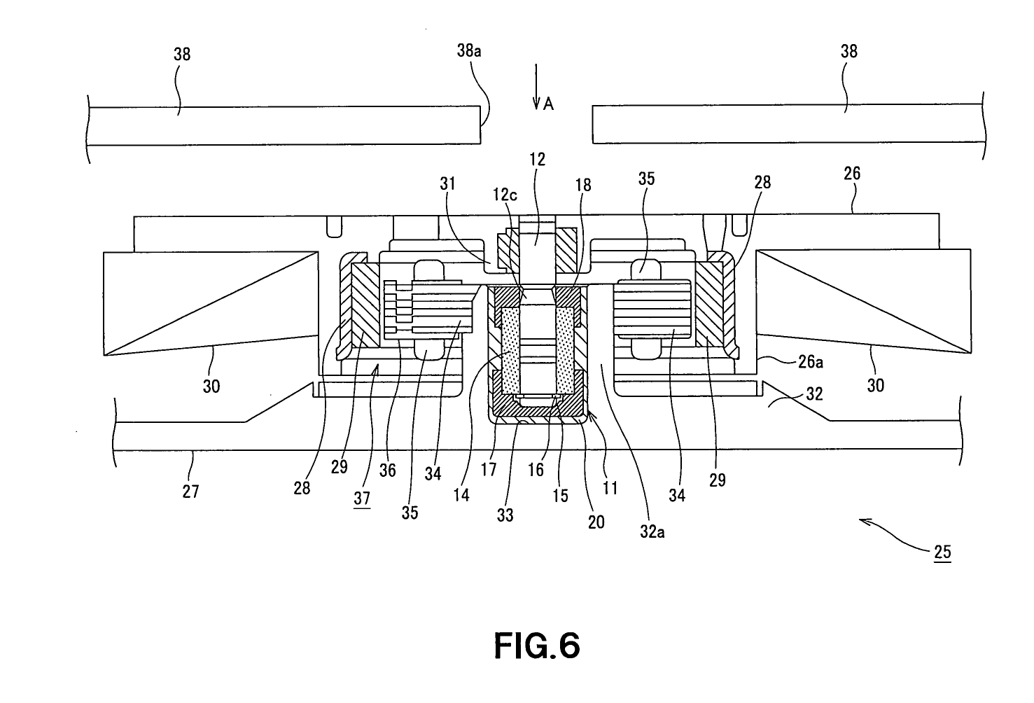

Now, a rotary driving apparatus using the bearing unit according to the present invention will be described below by referring to FIG. 6.

A rotary driving apparatus 25 shown in FIG. 6 specifically forms a fan motor of a personal computer.

The rotary driving apparatus 25 shown in FIG. 6 includes a rotor part 26 and a stator part 27 using the bearing unit 11 shown in FIG. 3.

The rotor part 26 forming a rotor includes a rotor yoke 28, a magnet 29 and a plurality of fan vanes 30. An end part of a rotating shaft 12 is fitted under pressure and fixed to a boss part 31 formed at a position as a center of rotation. Then, to the inner peripheral surface of the rotor yoke 28, the annular magnet 29 magnetized along the direction of a circumference is bonded and fixed. On the outer peripheral surface of a cylindrical part 26a forming the rotor part 26, the plurality of fan vanes 30 are provided at intervals of prescribed angles along the direction of the circumference. Here, as the magnet 29, a plastic magnet is used.

The bearing unit 11 is disposed in the stator part 27 as shaft supporting means for supporting the shaft 12 rotating together with the rotor part 26 so as to freely rotate. That is, the bearing unit 11 is fitted to a recessed part 33 of a cylindrical support part 32a formed in a stator yoke 32 forming the stator part 27 and further fixed thereto by using an adhesive. A coil part 36 including a core 34 and a coil 35 is provided at a position of an outer peripheral part of the support part 32a opposed to the inner peripheral surface of the magnet 29 and forms a driving part 37 of the rotor together with the magnet 29 and the rotor yoke 28.

A hole 38a is formed on a case 38 of the rotary driving apparatus 25. When the rotor part 26 is rotated by supplying electric current to the coil part 36, air enters from the hole 38a as shown by an arrow mark A in FIG. 6, and then, is discharged outside the case 38 from an air supply port (not shown) formed in the case 38.

As described above, the bearing unit 11 according to the present invention is mounted on the rotary driving apparatus 25, so that the rotary driving apparatus 25 having no leakage of lubricating oil and long life and excellent in its reliability can be realized. Further, the fluid dynamic bearing is used as the radial bearing 14, so that the rotary driving apparatus 25 having no leakage of lubricating oil and high reliability and capable of realizing a high speed rotation can be formed. Accordingly, the rotary driving apparatus may be advantageously applied to a cooling fan of a heat generating device that requires a high cooling performance.

Further, when the rotary driving apparatus 25 according to the present invention is applied to a cooling system of a heat generator such as a CPU used for a computer, the rotary driving apparatus can be applied to a cooling mechanism which transmits heat generated from the heat generator to a heat sink, and carries out air cooling of this heat sink by a fan.

The rotary driving apparatus 25 according to the present invention may be installed irrespective of upper and lower directions along the shaft 12. Accordingly, the rotary driving apparatus can be installed in an electronic device such as a personal computer by inverting upper and lower parts from a state shown in FIG. 6.

The rotary driving apparatus 25 according to the present invention is not limited to a cooling fan motor and may be widely applied to a rotating device of a disc type recording medium or a driving motor of a rotary type head drum device or the like.

The rotary driving apparatus 25 according to the present invention can use either the bearing unit 11, 11A or 11B.

As described above, in the bearing unit according to the present invention, the housing member is formed by using the polymer material and has the coefficient of thermal contraction relatively larger than that of the radial bearing made of the sintered metal or the like and supported by the housing member. A condition of n<m that the radial thickness n of the housing member is smaller than the radial thickness m of the radial bearing is satisfied. Thus, when the housing member is outsert-molded, the stress to the direction of the inside diameter due to the thermal contraction of the housing member is reduced. Therefore, the bearing unit in which the accuracy of inside diameter of the radial bearing can be sufficiently maintained, a necessary clearance is assured between the shaft and the radial bearing and loss torque is decreased can be realized.

Further, in the bearing unit according to the present invention, a good lubrication and long life can be obtained and reliability can be improved without aged deterioration.

Further, since the thickness of the housing member formed by molding the synthetic resin is small, the dimensional accuracy of its outside diameter is easily maintained.

Still further, when the bearing unit according to the present invention is attached to the device such as the driving motor, the bearing unit can be accurately fixed to the device by simply fitting it to a part of the device and a mechanical accuracy related to a rotation can be improved. When the bearing unit is applied to the above-described rotary driving apparatus, a relative positional relation between the magnet and the coil part can be satisfactorily maintained and a stable magnetic circuit can be obtained.

Particularly, in the bearing unit according to the present invention, the fluid dynamic bearing is used for the radial bearing. Thus, assuming that a quantity of gap between the shaft and the bearing is c and the depth of the dynamic pressure generating groove is h, (c+h)/c is very important. The value of a load capacity depends on the value of this ratio. That is, when the value of the ratio is lower than a certain tolerance or when the value of the ratio exceeds the tolerance, the dynamic pressure is reduced. Thus, whether or not the performance of the fluid dynamic bearing is exhibited as designed depends on the maintenance of the accuracy of the quantity of gap c. In the bearing unit according to the present invention, since the effect of the stress to the bearing upon thermal contraction can be eliminated to assure a prescribed quantity of gap, the shaft can be highly accurately supported and the stable rotation of the shaft can be assured.

Still further, since the radial bearing is relatively thicker than the housing member, the sufficient rigidity of the housing member is obtained. Accordingly, the resin material forming the housing member is easily selected and the conditions upon molding are easily set.

The present invention is not limited to the above-described embodiments explained with reference to the drawings. It is apparent to a person with ordinary skill in the art that various changes, substitutions or equivalence thereto may be made without departing the attached claims and the gist thereof.

Industrial Applicability

As described above, in the bearing unit according to the present invention, the mechanical accuracy of the inside diameter of the radial bearing for supporting the shaft can be easily maintained, the shaft can be highly accurately supported and the stable rotation of the shaft can be assured. The stable rotation of the rotary driving apparatus using the bearing unit can be assured.

1. A bearing unit having a shaft, a radial bearing for supporting the shaft so as to freely rotate and a housing member made of a resin for holding the radial bearing, wherein the housing member is formed with a material having a coefficient of thermal contraction larger than that of a material used for the radial bearing, and assuming that the radial thickness of the radial bearing means is m and the radial thickness of a part of the housing member with which the outer periphery of the radial bearing means is covered is n, a relation of m>n is satisfied.

2. The bearing unit according to claim 1, wherein a thrust bearing for receiving a thrust load exerted on the shaft is provided and the radial bearing and the thrust bearing are held by the housing member formed by using a resin material.

3. The bearing unit according to claim 1, wherein a fluid dynamic bearing is used as the radial bearing means.

4. The bearing unit according to claim 1, wherein a polymer material is used for the housing member.

5. A rotary driving apparatus including a rotor and a shaft rotating together with the rotor, a radial bearing means for supporting the shaft so as to freely rotate, a housing member made of a resin for holding the radial bearing means and a driving means for rotating the rotor, wherein the housing member is formed with a material having a coefficient of thermal contraction larger than that of a material used for the radial bearing means, and assuming that the radial thickness of the radial bearing means is m and the radial thickness of a part of the housing member with which the outer periphery of the radial bearing means is covered is n, a relation of m>n is satisfied.

6. The rotary driving apparatus according to claim 5, wherein a thrust bearing means for receiving a thrust load exerted on the shaft is provided and the radial bearing and the thrust bearing are held by the housing member formed by using a resin material.

7. The rotary driving apparatus according to claim 5, wherein a fluid dynamic bearing is used as the radial bearing means.

8. The rotary driving apparatus according to claim 5, wherein a polymer material is used for the housing member.
